(19) United States
(12) Patent Application Publication
(10) Pub. No.: US 2001/0022472 A1
(43) Pub. Date: Sep. 20, 2001

(54) METHOD AND APPARATUS FOR PROVIDING UNINTERRUPTED POWER DURING TRANSITIONS BETWEEN A POWER SOURCE AND A STANDBY GENERATOR USING CAPACITOR SUPPLIED VOLTAGE

(76) Inventors: GEORGE CODINA, PLAYA DEL REY, CA (US); THOMAS J. RICHARDS, PEORIA, IL (US)

Correspondence Address: STEVE D LUNDQUIST, CATERPILLAR INC PATENT DEPARTMENT, AB6490 100 NE ADAMS STREET, PEORIA, IL, 616296490

(21) Appl. No.: 09/408,708

(22) Filed: Sep. 30, 1999

(51) Int. Cl. H02J 9/00

(52) U.S. Cl. 307/66

(57) ABSTRACT

A method and apparatus for providing uninterrupted power during transitions between a primary power source and a standby power generator. The method and apparatus includes determining one of a power failure condition and a power return condition of the primary power source, transitioning between the primary power source and the standby power generator, and providing power to a load during the transition, the power being supplied by an uninterruptable power supply (UPS) having a capacitor supplied voltage.

### TECHNICAL FIELD

This invention relates generally to a method and apparatus for providing uninterrupted power to a load during transitions between a primary power source and a standby power generator and, more particularly, to a method and apparatus for providing uninterrupted power using a capacitor supplied voltage.

### BACKGROUND ART

It has long been a common practice to start standby power generators using the energy stored in batteries to drive starter motors, which in turn crank the generator until the generator starts. However, the load placed upon the batteries reduces the life of service of the batteries significantly. A typical battery for starting a standby power generator may only have a useful life of about three years. In addition, the power output of even a good battery may be severely reduced when used under extreme temperature conditions.

Advances have been made in technology regarding capacitors, which are capable of storing electrical energy, but until recently were not capable of storing the amounts of energy needed to start a generator. However, large capacitance capacitors, for example electric double layer capacitors, have been developed which are capable of storing large amounts of electrical energy. These capacitors are sometimes known as super capacitors, and are finding use in applications such as in engine starting circuits.

Although the transition between a primary power source and a standby power generator may be accomplished very quickly, the brief interruption in power may have an adverse effect on some types of loads; for example, sensitive electronic equipment, digital clocks, timers, and the like. For this reason, uninterruptable power supplies (UPS) are commonly used to prevent power interruptions of any duration.

Typically, a UPS uses batteries to provide the electric power needed during the transition periods between primary power sources and generators. However, as described above, batteries have limited useful lives (about three years) due to the loads placed upon them. In addition, batteries do not function as well under extreme climate conditions. In a situation where a UPS must supply a large amount of power, the batteries needed may require a dedicated room or building to house them. In extreme climate conditions, e.g., extreme cold climates, the dedicated housings for the batteries would need to be climate controlled, thus requiring additional complex and costly equipment.

The present invention is directed to overcoming one or more of the problems as set forth above.

### DISCLOSURE OF THE INVENTION

In one aspect of the present invention a method for providing uninterrupted power during transitions between a primary power source and a standby power generator is disclosed. The method includes the steps of determining one of a power failure condition and a power return condition of the primary power source, transitioning between the primary power source and the standby power generator, and providing power to a load during the transition, the power being supplied by an uninterruptable power supply (UPS) having a capacitor supplied voltage.

In another aspect of the present invention an apparatus for providing uninterrupted power during transitions between a primary power source and a standby power generator is disclosed. The apparatus includes a transfer switch adapted to determine one of a power failure condition and a power return condition of the primary power source, and responsively transition between the primary power source and the standby power generator, an uninterruptable power supply (UPS) for providing power to a load during the transition, and at least one capacitor electrically connected to the UPS for providing the power to the load.

### BRIEF DESCRIPTION OF THE DRAWINGS

FIG. 1 is an electrical block diagram illustrating a preferred embodiment of the present invention;

FIG. 2 is a power vs. time graph illustrating charging and discharging times of a capacitor used in the circuit of FIG. 1;

FIG. 3 is a current vs. time graph illustrating current delivery vs. time of a capacitor and a battery; and

FIG. 4 is a flow diagram illustrating a preferred method of the present invention.

### BEST MODE FOR CARRYING OUT THE INVENTION

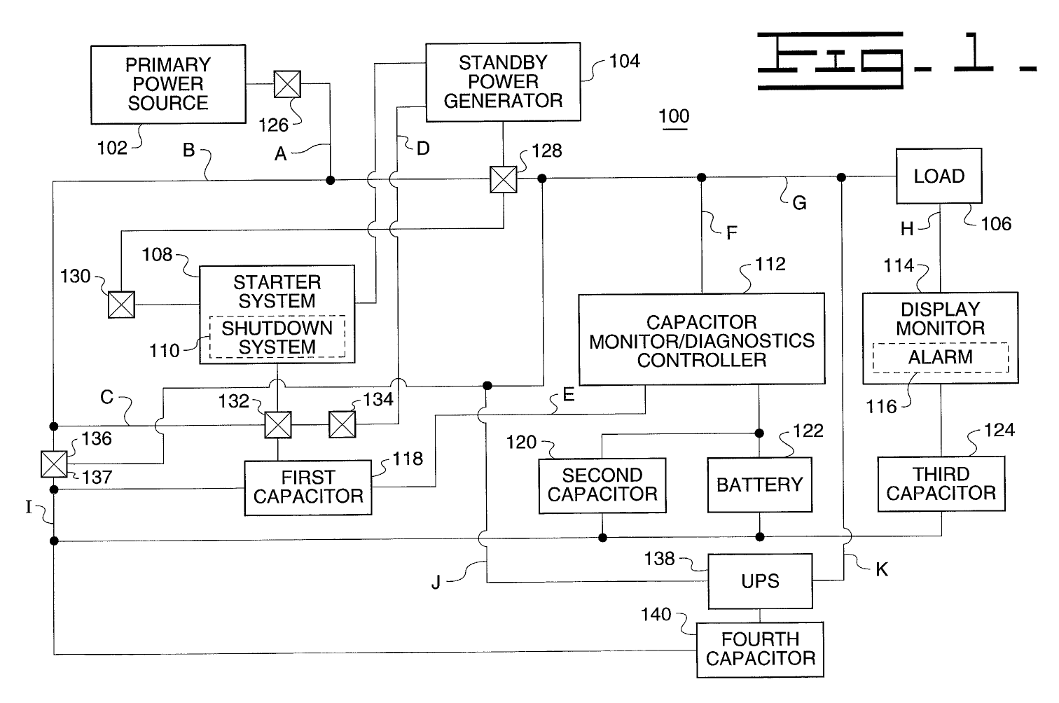

Referring to the drawings, and with particular respect to FIG. 1, a diagrammatic illustration of a preferred embodiment of the present invention is shown. It is noted that the embodiment shown in FIG. 1 is illustrative of but one aspect of a preferred apparatus 100 suitable for use with the present invention. Variations of the apparatus 100 may be employed which are suitable for use with the invention as described below with respect to the specification and the accompanying claims.

A primary power source 102 provides primary electrical power to a load 106. The primary power source may be of any type well known in the art, such as electrical power provided by an electrical power utility company, or an electrical power generating station of some type.

A standby power generator 104 having a capacity suitable for providing standby electrical power to the load 106 is available to provide standby power during periods of time of power failure of the primary power source 102. Typically, the standby power generator 106 is driven by an internal combustion engine (not shown), as is well known in the art.

A transfer switch 128, electrically connected between the primary power source 102, the standby power generator 104, and the load 106, is adapted to determine a power failure condition of the primary power source 102, disconnect the primary power source 102 from the load 106, and connect the standby power generator to the load 106. In addition, the transfer switch 128 is adapted to enable a starter system enable switch 130, which in turn is adapted to enable a starter system 108.

Preferably, the starter system 108 is of a type typically used to start internal combustion engines, and is therefore well known in the art.

A starter system activate switch 132 is adapted to sense the loss of electrical power from the primary power source 102 via electrical path A-B-C, and responsively activate the starter system 108 by connecting a first capacitor 118 to the starter system 108. In the preferred embodiment, the first capacitor 118 is of a type commonly known as a super capacitor, e.g., an electric double layer capacitor, and is capable of storing electrical energy sufficient to provide a voltage to drive the starter system 108 to start the standby power generator 104.

A starter system deactivate switch 134 monitors the speed of the standby power generator 104 via path D, and is adapted to cause the starter system activate switch 132 to disconnect the first capacitor 118 from the starter system 108 in response to the speed of the generator 104 being a predetermined minimum value for a predetermined length of time, thus stopping the starting operation of the starter system 108. For example, if the speed of the generator 104 is determined to be 1500 rpm for 5 seconds, the generator 104 is determined to be running, and the starter system 108 is disengaged.

The transfer switch 128 is further adapted to determine a power return condition of the primary power source 102, and responsively disconnect the standby power generator 104 from the load 106, and reconnect the primary power source 102 to the load 106. In addition, the transfer switch 128 is adapted to shut down the standby power generator 104 by disengaging the starter system enable switch 130 which responsively activates a shutdown system 110, which is part of the starter system 108.

A capacitor monitor/diagnostics controller 112 is adapted via path E to monitor the energy storage of the first capacitor 118, and to periodically discharge and charge, i.e., exercise, the first capacitor 118 to maintain a maximum desired energy storage. In addition, the capacitor monitor/diagnostics controller 112 is adapted to generate a signal indicating the condition of the first capacitor 118, and to deliver the signal to a display monitor 114, which is described in more detail below. In addition, the capacitor monitor/diagnostics controller 112 may be adapted to perform the above functions with second, third, and fourth capacitors 120, 124, 140, although the corresponding paths to these capacitors, i.e., corresponding to path E, are not shown in FIG. 1.

In the preferred embodiment, the capacitor monitor/diagnostics controller 112 receives electrical power, during the transition period between the primary power source 102 and the standby power generator 104, from a second capacitor 120 in combination with a battery 122. Preferably, the second capacitor 120 is of the type commonly known as a super capacitor, and provides the voltage to the capacitor monitor/diagnostics controller 112 during the transition period, and the battery 122 provides a charging voltage to the second capacitor 120. Alternatively, the second capacitor 120 may have a capacity to provide the voltage directly without the use of a battery to charge the second capacitor 120. In this alternative embodiment, the battery 122 would not be used.

A display monitor 114 is adapted to display a status condition of at least one of the primary power source 102, the standby power generator 104, the starter system 108, and the first capacitor 118. In addition, the display monitor 114 may be adapted to display other types of information including, but not limited to, the status of the transfer switch 128, additional operating parameters of the standby power generator 104, the status of other switches in the apparatus 100, and the like.

In one embodiment, the display monitor receives information through the electrical paths in the apparatus 100. For example, the status of the first capacitor 118 may be delivered to the display monitor 114 from the capacitor monitor/diagnostics controller 112 via path F-G-H.

In another embodiment, the display monitor 114 is located at a remote location and the information is delivered by some other means known in the art, such as telephone lines, wireless radio, microwave, dedicated lines, and the like.

Preferably, the display monitor 114 includes an alarm 116, either audio or visual or both, to notify operating personnel of status conditions requiring attention, such as failure of the primary power source 102, or an abnormal parameter of the standby power generator 104.

The display monitor 114 preferably receives electrical power, during the transition period between the primary power source 102 and the standby power generator 104, from a third capacitor 124. In the preferred embodiment, the third capacitor 124 is of the type commonly known as a super capacitor, and thus has the capacity to provide power to the display monitor 114 during the transition period.

An uninterruptable power supply (UPS) 138 is electrically connected to the apparatus 100 and is adapted to determine a transition between the primary power source 102 and the standby power supply 104 via path J. During this transition period, no voltage is applied to the load 106. The UPS is adapted to responsively apply a voltage to the load 106 during the transition period via path K.

In the preferred embodiment, the UPS 138 provides the voltage to the load 106 by means of a fourth capacitor 140. Preferably, the fourth capacitor 140 includes at least one capacitor, the number of capacitors being a function of the size of the load 106. For example, for a relatively small load, one capacitor may be adequate, and a relatively large load may require more capacitors. The use of the fourth capacitor 140 with the UPS 138 eliminates the need for batteries, thus reducing maintenance, battery replacement costs, and the need for climate control.

The first, second, third, and fourth capacitors 118, 120, 124, 140 are charged by either the primary power source 102 or the standby power generator 104 through a capacitor charge switch 136 via path I. The capacitor charge switch 136 is adapted to determine a failure of the primary power source 102 and switch to the standby power generator 104 in response. Preferably, the capacitor charge switch 136 includes an AC to DC converter 137 to provide a DC voltage to charge the first, second, third, and fourth capacitors 118, 120, 124, 140.

A system test switch 126, connected in line with the primary power source 102 along path A, may be used to simulate failure of the primary power source 102 for testing and diagnostics purposes.

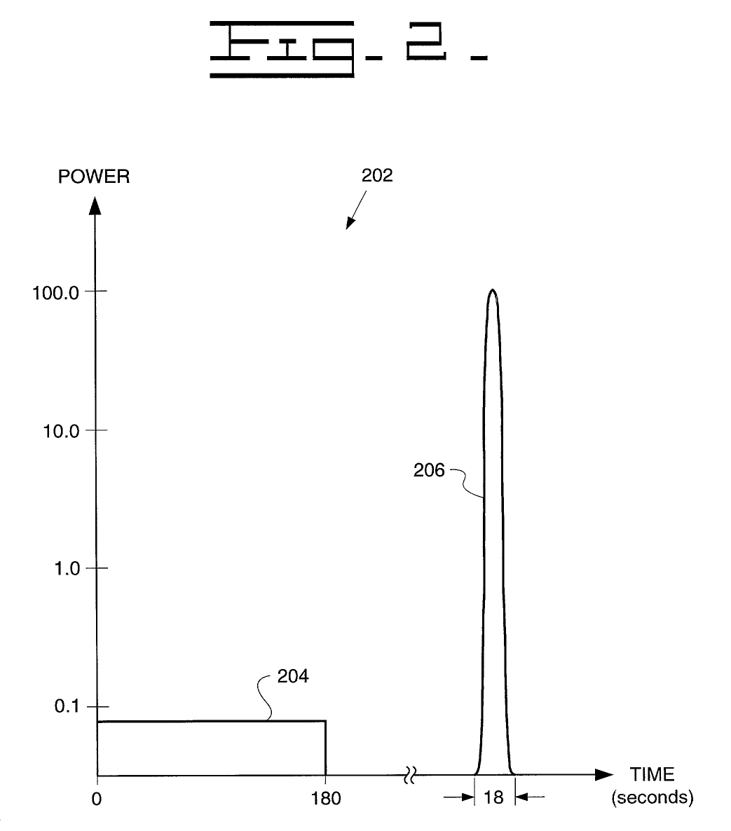

Referring now to FIG. 2, a graph 202 of power vs. time is shown. It is noted that the scales on the axis are exemplary only, and do not indicate any values that are necessary for the present invention. For example, the vertical axis, i.e., power, is not assigned any units of measurement, and the values given are merely arbitrary.

A representation 204 of power vs. time of the capacitor 118 charging illustrates that the capacitor 118 is charged for a relatively long period of time, for example 180 seconds, at low power. Under these conditions, the power drain is minimized during charging of the capacitor 118.

The power vs. time curve 206 of the first capacitor 118 discharging, for example, when used to drive the starter system 108 to start the standby power generator 104, indicates that the capacitor 118 discharges a large amount of power in a short period of time. For example, the capacitor 118 may discharge in about 18 seconds, or about one tenth of the time that it took to charge the capacitor 118. The process of charging the capacitor 118 at low power over a long period of time and then discharging the capacitor 118 at high power over a short period of time is known as energy compression, or pulse power. It is noted that the 180 second charge time, the 18 second discharge time, and the 10 to 1 energy compression ratio are merely examples used for purposes of illustration. Other charge and discharge times and ratios may be used without deviating from the invention.

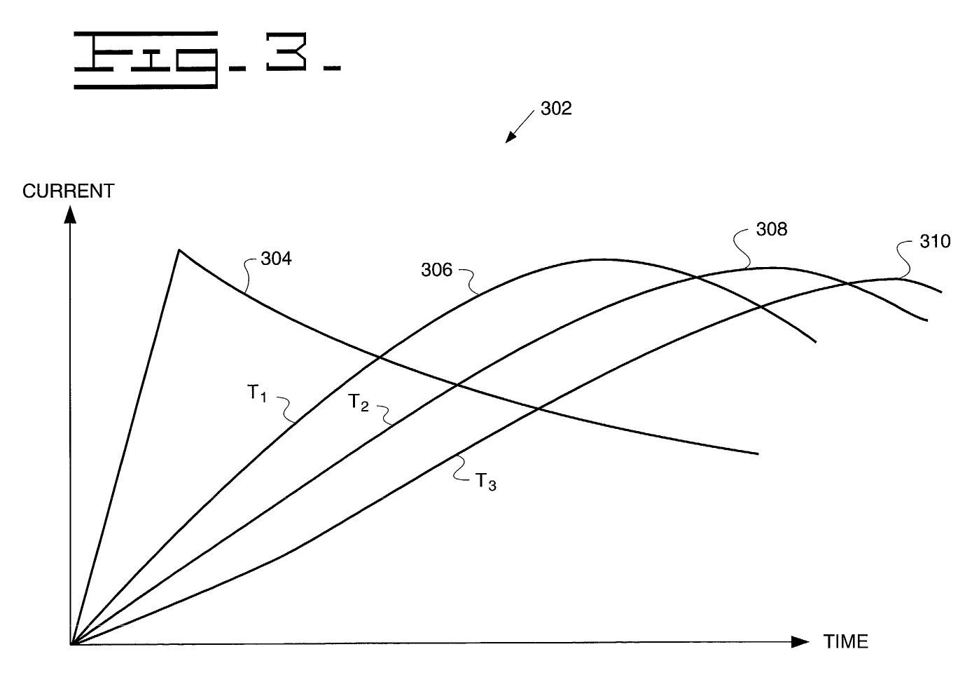

Referring now to FIG. 3, a graph 302 of current vs. time is shown. It is noted that the axes of the graph 302 are not drawn to any scale and do not depict any units of measurement. The curves shown on the graph are being used to illustrate comparative features for purposes of illustration only.

A curve 304 of the current vs. time of the capacitor 114 illustrates that the capacitor 118 is capable of providing a maximum value of current quickly, which then slowly decreases as the capacitor 118 is discharged. It is noted that the curve 304 of the capacitor 118 is independent of temperature.

Curves 306, 308, 310 of the current vs. time of a battery (not shown), typically used to drive a starter system, at three temperatures T₁, T₂, T₃ illustrate that the battery takes longer than the capacitor 118 to provide maximum current for purposes of starting the standby power generator 104. In addition, T₃ is a lower temperature than T₂, which is a lower temperature than T₁. Therefore, as shown in the graph 302, as the temperature decreases, the length of time for the battery to reach maximum current output increases. This results in longer starting times in cold conditions, which places additional stress on the battery. In addition, the internal resistance of the battery 104 increases as the temperature decreases. The higher internal resistance lowers the maximum output current of the battery 104. Therefore, as shown in FIG. 3, as the temperature decreases, the maximum output current of the battery 104 decreases.

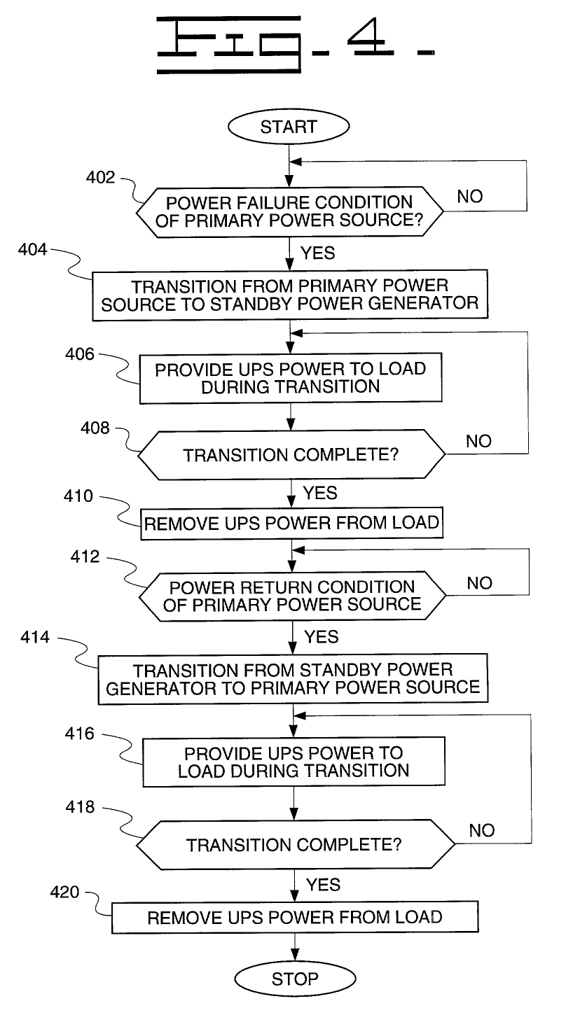

Referring now to FIG. 4, a flow diagram illustrating a preferred method of the present invention is shown.

In a first decision block 402, the transfer switch 128 determines if a power failure condition of the primary power source 102 has occurred. If a power failure condition has occurred, control proceeds to a first control block 404, where the transfer switch 128 transitions from the primary power source 102 to the standby power generator 104.

In a second control block 406, the UPS 138 provides power to the load 106 during the transition. The UPS 138, as described above, provides power by means of at least one capacitor, i.e., the fourth capacitor 140.

In a second decision block 408, it is determined if the transition from the primary power source 102 to the standby power supply 104 is complete; that is, if the standby power supply 104 is now applying power to the load 106. If the transition is complete, the power delivered by the UPS 138 is removed from the load 106, as depicted in a third control block 410.

In a third decision block 412, it is determined if a power return condition of the primary power source 102 exists, i.e., if the primary power source 102 has resumed the ability to deliver power. If the power return condition exists, control proceeds to a fourth control block 414, where the transfer switch 128 provides the transition from the standby power generator 104 to the primary power source 102.

In a fifth control block 416, the UPS 138 provides power to the load 106 during the transition. The UPS 138, as described above, provides power by means of at least one capacitor, i.e., the fourth capacitor 140.

In a fourth decision block 418, it is determined if the transition from the standby power generator 104 to the primary power source 102 is complete; that is, if the primary power source 102 is now applying power to the load 106. If the transition is complete, the power delivered by the UPS 138 is removed from the load 106, as depicted in a sixth control block 420.

### Industrial Applicability

As an example of an application of the present invention, the fourth capacitor 140 is used to provide electrical power to the load 106 of FIG. 1 during the transition periods of time between the primary power source 102 and the standby power generator 104. The fourth capacitor 140 is commonly known as a super capacitor; that is, the fourth capacitor 140 has a much greater capacity to store electrical energy than typical capacitors.

Historically, batteries have been used to provide the electrical power that is provided in the present invention by the fourth capacitor 140. However, batteries require much more maintenance, have a much shorter useful life, e.g., about three years, and do not function well under extreme environmental conditions, such as extreme cold temperatures. The fourth capacitor 140 is configured and chosen to have the storage capacity to provide the electrical power needed during transition periods without the inherent disadvantages of maintaining batteries in the system.

Other aspects, objects, and features of the present invention can be obtained from a study of the drawings, the disclosure, and the appended claims.

1. A method for providing uninterrupted power during transitions between a primary power source and a standby power generator, including the steps of:
determining one of a power failure condition and a power return condition of the primary power source;
transitioning between the primary power source and the standby power generator; and
providing power to a load during the transition, the power being supplied by an uninterruptable power supply (UPS) having a capacitor supplied voltage.

2. A method, as set forth in claim 1, wherein the capacitor supplied voltage is provided by at least one capacitor.

3. A method, as set forth in claim 1, further including the step of removing the UPS supplied voltage in response to determining power being supplied to the load by one of the primary power source and the standby power generator.

4. A method, as set forth in claim 2, further including the step of maintaining a charge on the at least one capacitor by applying a voltage from one of the primary power source and the standby power generator.

5. An apparatus for providing uninterrupted power during transitions between a primary power source and a standby power generator comprising:
a transfer switch adapted to determine one of a power failure condition and a power return condition of the primary power source, and responsively transition between the primary power source and the standby power generator;
an uninterruptable power supply (UPS) for providing power to a load during the transition; and
at least one capacitor electrically connected to the UPS for providing the power to the load.

6. An apparatus, as set forth in claim 5, further including a capacitor monitor/diagnostics controller for monitoring the energy storage of the at least one capacitor, and discharging and recharging the at least one capacitor to maintain a maximum desired energy storage.
